(19) United States
(12) Patent Application Publication
(10) Pub. No.: US 2007/0050520 A1
(43) Pub. Date: Mar. 1, 2007

(54) SYSTEMS AND METHODS FOR MULTI-HOST EXTENSION OF A HIERARCHICAL INTERCONNECT NETWORK

(75) Inventor: Dwight D. RILEY, Houston, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: HEWLETT-PACKARD DEVELOPMENT COMPANY, L.P., Houston, TX (US)

(21) Appl. No.: 11/553,682

(22) Filed: Oct. 27, 2006

Related U.S. Application Data
(63) Continuation-in-part of application No. 11/078,851, filed on Mar. 11, 2005.
(60) Provisional application No. 60/552,344, filed on Mar. 11, 2004.

(51) Int. Cl. G06F 15/173

(52) U.S. Cl. 709/239

(57) ABSTRACT

The present disclosure describes systems and methods for multi-host extension of a hierarchical interconnect network. Some illustrative embodiments include a computer system, which includes a first system node comprising a first processor, a second system node comprising a second processor, and a network switch fabric coupling together the first and second system nodes (the network switch fabric comprises a rooted hierarchical bus). Identification information within a transaction is translated into a rooted hierarchical bus end-device identifier. The transaction is transmitted from the first system node to the second system node, the transaction routed across the network switch fabric based upon the rooted hierarchical bus end-device identifier.

### CROSS-REFERENCE TO RELATED APPLICATION

The present application is a continuation-in-part of, and claims priority to, co-pending application Ser. No. 11/078,851, filed Mar. 11, 2005, and entitled “System and Method for a Hierarchical Interconnect Network,” which claims priority to provisional application Ser. No. 60/552,344, filed Mar. 11, 2004, and entitled “Redundant Path PCI Network Hierarchy,” both of which are hereby incorporated by reference. The present application is also related to co-pending application Ser. No. 11/450,491, filed Jun. 9, 2006, and entitled “System and Method for Multi-Host Sharing of a Single-Host Device,” which is also hereby incorporated by reference.

### BACKGROUND

Ongoing advances in distributed multi-processor computer systems have continued to drive improvements in the various technologies used to interconnect processors, as well as their peripheral components. As the speed of processors has increased, the underlying interconnect, intervening logic, and the overhead associated with transferring data to and from the processors have all become increasingly significant factors impacting performance. Performance improvements have been achieved through the use of faster networking technologies (e.g., Gigabit Ethernet), network switch fabrics (e.g., Infiniband, and RapidIO®), TCP offload engines, and zero-copy data transfer techniques (e.g., remote direct memory access). Efforts have also been increasingly focused on improving the speed of host-to-host communications within multi-host systems. Such improvements have been achieved in part through the use of high-speed network and network switch fabric technologies. However, networks and network switch fabrics may add communication protocol layers that can adversely affect performance, and may further require the use of proprietary hardware and software.

### BRIEF DESCRIPTION OF THE DRAWINGS

For a detailed description of exemplary embodiments of the invention reference will now be made to the accompanying drawings in which:

FIG. 1A shows a computer system constructed in accordance with at least some embodiments;

FIG. 1B shows the underlying rooted hierarchical structure of a switch fabric within a computer system constructed in accordance with at least some embodiments;

FIG. 2 shows a network switch constructed in accordance with at least some embodiments;

FIG. 3 shows the state of a computer system constructed in accordance with at least some embodiments after a reset;

FIG. 4 shows the state of a computer system constructed in accordance with at least some embodiments after identifying the secondary ports;

FIG. 5 shows the state of a computer system constructed in accordance with at least some embodiments after designating the alternate paths;

FIG. 6 shows an initialization method in accordance with at least some embodiments;

FIG. 7 shows a routing method in accordance with at least some embodiments;

FIG. 8 shows internal details of a compute node and an I/O node that are part of a computer system constructed in accordance with at least some embodiments;

FIG. 9 shows PCI-X® transactions encapsulated within PCI Express® transactions in accordance with at least some embodiments;

FIG. 10A shows components of a compute node and an I/O node combined to form a virtual hierarchical bus in accordance with at least some embodiments;

FIG. 10B shows a representation of a virtual hierarchical bus between components of a compute node and components of an I/O node in accordance with at least some embodiments;

FIG. 11 shows internal details of two compute nodes configured for multiprocessor operation that are part of a computer system constructed in accordance with at least some embodiments;

FIG. 12 shows HyperTransport™ transactions encapsulated within PCI Express® transactions in accordance with at least some embodiments;

FIG. 13A shows components of two compute nodes combined to form a virtual point-to-point multiprocessor interconnect in accordance with at least some embodiments;

FIG. 13B shows two illustrative embodiments of a virtual point-to-point multiprocessor interconnect interface;

FIG. 13C shows a representation of a virtual point-to-point multiprocessor interconnect coupling two CPUs and a virtual network interface in accordance with at least some embodiments;

FIG. 14 shows internal details of two compute nodes configured for network emulation that are part of a computer system constructed in accordance with at least some embodiments;

FIG. 15A shows components of several nodes and a network switch fabric combined to form a virtual network in accordance with at least some embodiments;

FIG. 15B shows two illustrative embodiments of a virtual network interface;

FIG. 15C shows a representation of a virtual network coupling two virtual machines in accordance with at least some embodiments;

FIG. 16 shows network messages using a socket structure encapsulated within PCI Express® transactions in accordance with at least some embodiments;

FIG. 17 shows a method for transferring a network message across a network switch fabric, in accordance with at least some embodiments; and

FIG. 18 shows a method for transferring a virtual point-to-point multiprocessor interconnect transaction across a network switch fabric, in accordance with at least some embodiments.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “software” refers to any executable code capable of running on a processor, regardless of the media used to store the software. Thus, code stored in non-volatile memory, and sometimes referred to as “embedded firmware,” is within the definition of software. Further, the term “system” refers to a collection of two or more parts and may be used to refer to an electronic device, such as a computer or networking system or a portion of a computer or networking system.

The term “virtual machine” refers to a simulation, emulation or other similar functional representation of a computer system, whereby the virtual machine comprises one or more functional components that are not constrained by the physical boundaries that define one or more real or physical computer systems. The functional components comprise real or physical devices, interconnect busses and networks, as well as software programs executing on one or more CPUs. A virtual machine may, for example, comprise a sub-set of functional components that include some but not all functional components within a real or physical computer system; may comprise some functional components of multiple real or physical computer systems, may comprise all the functional components of one real or physical computer system, but only some components of another real or physical computer system; or may comprise all the functional components of multiple real or physical computer systems. Many other combinations are possible, and all such combinations are intended to be within the scope of the present disclosure.

Similarly, the term “virtual bus” refers to a simulation, emulation or other similar functional representation of a computer bus, whereby the virtual bus comprises one or more functional components that are not constrained by the physical boundaries that define one or more real or physical computer busses Also, the term “virtual multiprocessor interconnect” refers to a simulation, emulation or other similar functional representation of a multiprocessor interconnect, whereby the virtual multiprocessor interconnect comprises one or more functional components that are not constrained by the physical boundaries that define one or more real or physical multiprocessor interconnects. Likewise, the term “virtual device” refers to a simulation, emulation or other similar functional representation of a real or physical computer device, whereby the virtual device comprises one or more functional components that are not constrained by the physical boundaries that define one or more real or physical computer devices. Like a virtual machine, a virtual bus, a virtual multiprocessor interconnect, and a virtual device may comprise any number of combinations of some or all of the functional components of one or more physical or real busses, multiprocessor interconnects, or devices, respectively, and the functional components may comprise any number of combinations of hardware devices and software programs Many combinations, variations and modifications will be apparent to those skilled in the art, and all are intended to be within the scope of the present disclosure.

Likewise, the term “virtual network” refers to a simulation, emulation or other similar functional representation of a communications network, whereby the virtual network comprises one or more functional components that are not constrained by the physical boundaries that define one or more real or physical communications networks. Like a virtual bus, a virtual network may comprise any number of combinations of some or all of the functional components of one or more physical or real networks, and the functional components may comprise any number of combinations of hardware devices and software programs. Many combinations, variations and modifications will be apparent to those skilled in the art, and all are intended to be within the scope of the present disclosure.

Additionally, the term “PCI-Express®” refers to the architecture and protocol described in the document entitled, “PCI Express Base Specification 1.1,” promulgated by the Peripheral Component Interconnect Special Interest Group (PCI-SIG), which is herein incorporated by reference. Similarly, the term “PCI-X®” refers to the architecture and protocol described in the document entitled, “PCI-X Protocol 2.0a Specification,” also promulgated by the PCI-SIG, and also herein incorporated by reference.

### DETAILED DESCRIPTION

The following discussion is directed to various embodiments of the invention Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

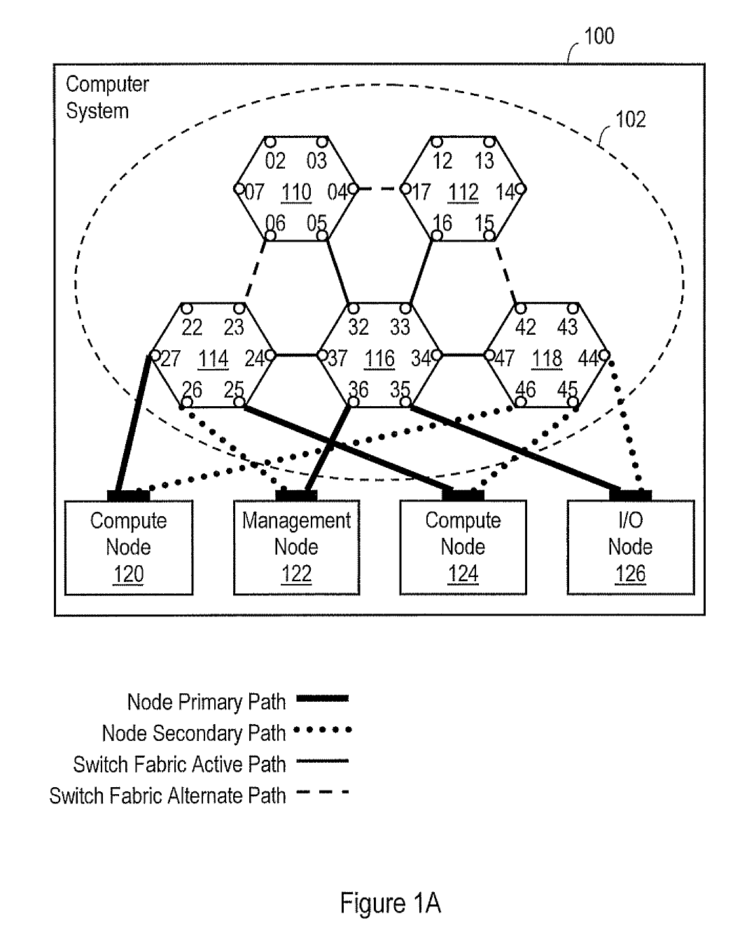

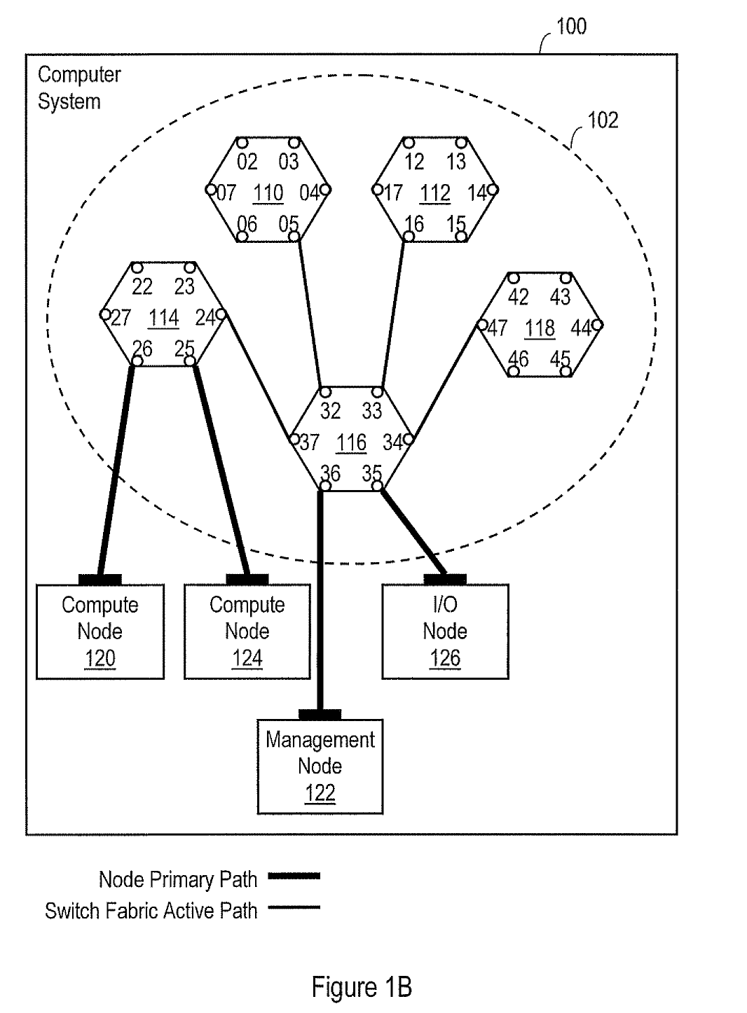

Interconnect busses have been increasingly extended to operate as network switch fabrics within scalable, high-availability computer systems (e.g., blade servers). These computer systems may comprise several components or “nodes” that are interconnected by the switch fabric. The switch fabric may provide redundant or alternate paths that interconnect the nodes and allow them to exchange data. FIG. 1A illustrates a computer system 100 with a switch fabric 102 comprising switches 110 through 118 and constructed in accordance with at least some embodiments The computer system 100 also comprises compute nodes 120 and 124, management node 122, and input/output (I/O) node 126.

Each of the nodes within the computer system 100 couples to at least two of the switches within the switch fabric. Thus, in the embodiment illustrated in FIG. 1A, compute node 120 couples to both port 27 of switch 114 and port 46 of switch 118; management node 122 couples to port 26 of switch 114 and port 36 of switch 116; compute node 124 couples to port 25 of switch 114 and port 45 of switch 118; and I/O node 126 couples to port 35 of switch 116 and port 44 of switch 118.

By providing both an active and alternate path a node can send and receive data across the switch fabric over either path based on such factors as switch availability, path latency, and network congestion Thus, for example, if management node 122 needs to communicate with I/O node 126, but switch 116 has failed, the transaction can still be completed by using an alternate path through the remaining switches. One such path, for example, is through switch 114 (ports 26 and 23), switch 110 (ports 06 and 04), switch 112 (ports 17 and 15), and switch 118 (ports 42 and 44).

Because the underlying rooted hierarchical bus structure of the switch fabric 102 (rooted at management node 122 and illustrated in FIG. 1B) does not support alternate paths as described, extensions to identify alternate paths are provided to the process by which each node and switch port is mapped within the hierarchy upon initialization of the switch fabric 102 of the illustrative embodiment shown. These extensions may be implemented within the switches so that hardware and software installed within the various nodes of the computer system 100, and already compatible with the underlying rooted hierarchical bus structure of the switch fabric 102, can be used in conjunction with the switch fabric 102 with little or no modification.

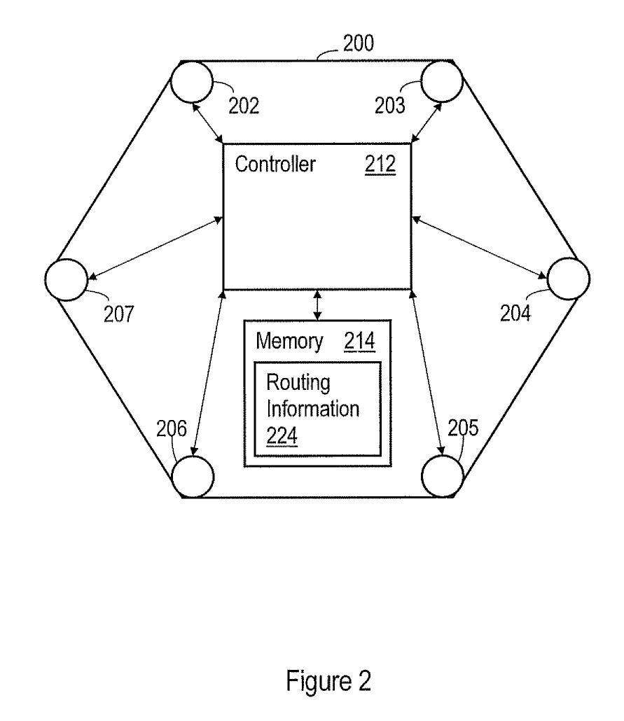

FIG. 2 illustrates a switch 200 implementing such extensions for use within a switch fabric, and constructed in accordance with at least some illustrative embodiments. The switch 200 comprises a controller 212 and memory 214, as well as a plurality of communication ports 202 through 207. The controller 212 couples to the memory 214 and each of the communication ports. The memory 214 comprises routing information 224. The controller 212 determines the routing information 224 upon initialization of the switch fabric and stores it in the memory 214. The controller 212 later uses the routing information 224 to identify alternate paths. The routing information 224 comprises whether a port couples to an alternate path, and if it does couple to an alternate path, which endpoints within the computer system 100 are accessible through that alternate path.

In at least some illustrative embodiments the controller 212 is implemented as a state machine that uses the routing information based on the availability of the active path. In other embodiments, the controller 212 is implemented as a processor that executes software (not shown). In such a software-driven embodiment the switch 200 is capable of using the routing information based on the availability of the active path, and is also capable of making more complex routing decisions based on factors such as network path length, network traffic, and overall data transmission efficiency and performance. Other factors and combinations of factors may become apparent to those skilled in the art, and such variations are intended to be within the scope of this disclosure.

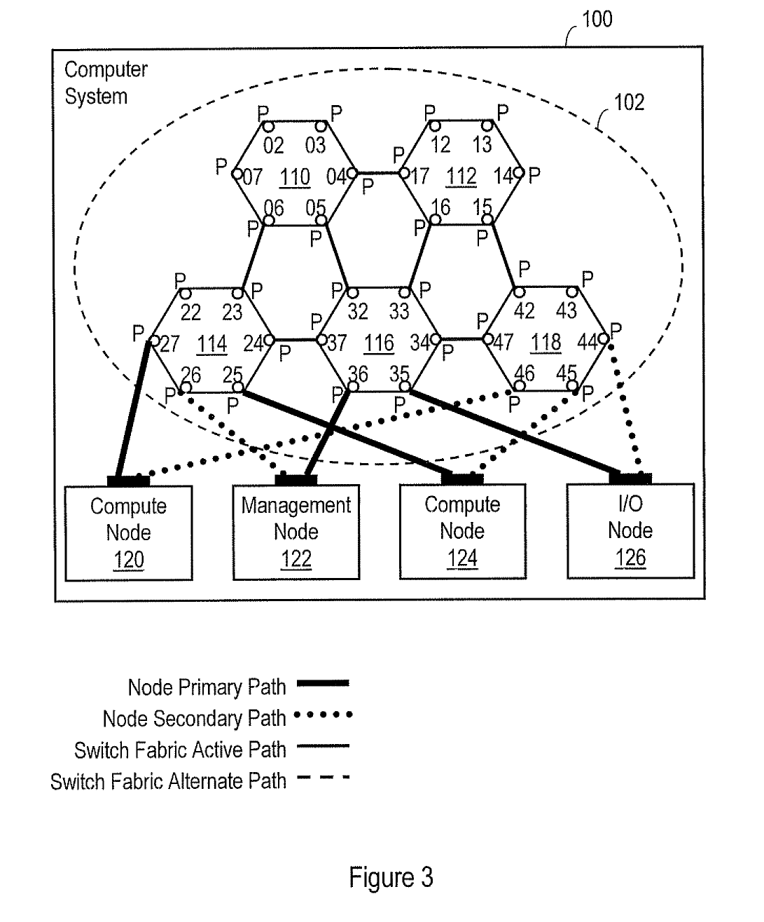

The initialization of the switch fabric may vary depending upon the underlying rooted hierarchical bus architecture. FIGS. 3 through 5 illustrate initialization of a switch fabric based upon a peripheral component interconnect (PCI) architecture and in accordance with at least some illustrative embodiments. Referring to FIG. 3, upon resetting the computer system 100, each of the switches 110 through 118 identifies each of their ports as primary ports (designated by a “P” in FIG. 3). Similarly, the paths between the switches are initially designated as active paths. The management node then begins a series of one or more configuration cycles in which each switch port and endpoint within the hierarchy is identified (referred to in the PCI architecture as “enumeration”), and in which the primary bus coupled to the management node is designated as the root complex on the primary bus. Each configuration cycle comprises accessing configuration data stored in the each device coupled to the switch fabric (e.g., the PCI configuration space of a PCI device). The switches comprise data related to devices that are coupled to the switch. If the configuration data regarding other devices stored by the switch is not complete, the management node initiates additional configuration cycles until all devices coupled to the switch have been identified and the configuration data within the switch is complete.

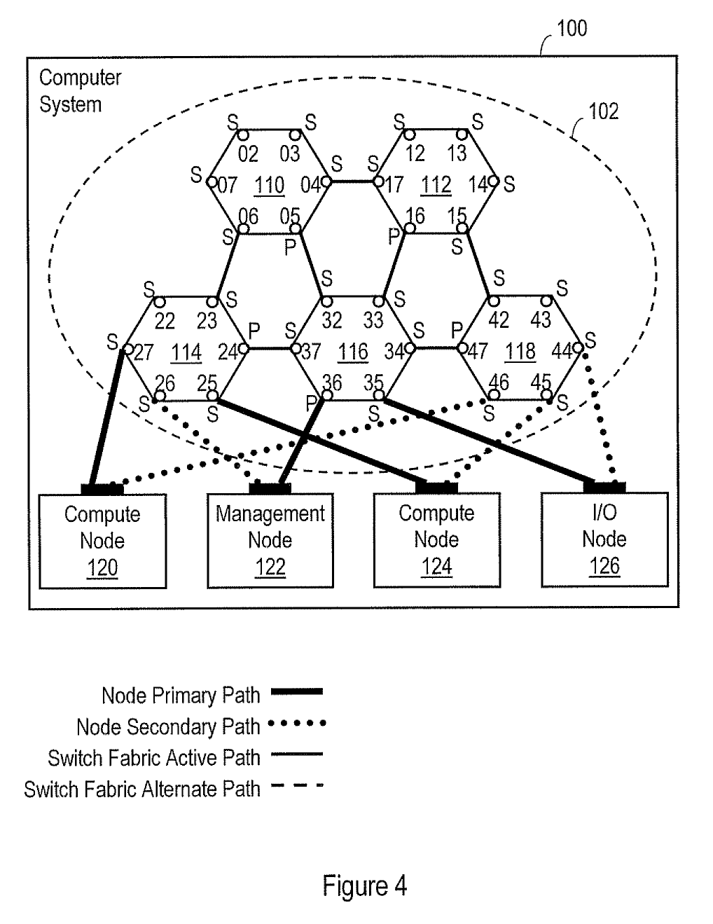

Referring now to FIG. 4, when switch 116 detects that the management node 122 has initiated a first valid configuration cycle on the root bus, switch 116 identifies all ports not coupled to the root bus as secondary ports (designated by an “S” in FIG. 4). Subsequent valid configuration cycles may be propagated to each of the switches coupled to the secondary ports of switch 116, causing those switches to identify as secondary each of their ports not coupled to the switch propagating the configuration cycle (here switch 116). Thus, switch 116 will end up with port 36 identified as a primary port, and switches 110, 112, 114, and 118 with ports 05, 16, 24, and 47 identified as primary ports, respectively.

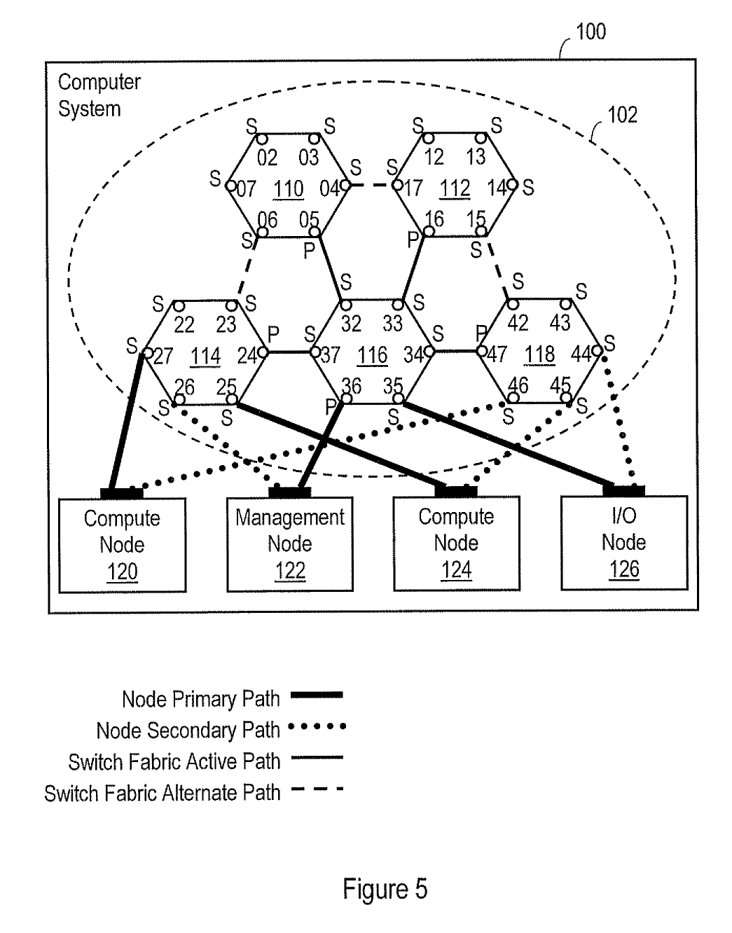

As ports are identified during each valid configuration cycle of the initialization process, each port reports its configuration (primary or secondary) to the port of any other switch to which it is coupled. Once both ports of two switches so coupled to each other have initialized, each switch determines whether or not both ports have been identified as secondary. If at least one port has not been identified as a secondary port, the path between them is designated as an active path within the bus hierarchy. If both ports have been identified as secondary ports, the path between them is designated as a redundant or alternate path. Routing information regarding other ports or endpoints accessible through each switch (segment numbers within the PCI architecture) is then exchanged between the two ports at either end of the path coupling the ports, and each port is then identified as an endpoint within the bus hierarchy. The result of this process is illustrated in FIG. 5, with the redundant or alternate paths shown by dashed lines between coupled secondary switch ports.

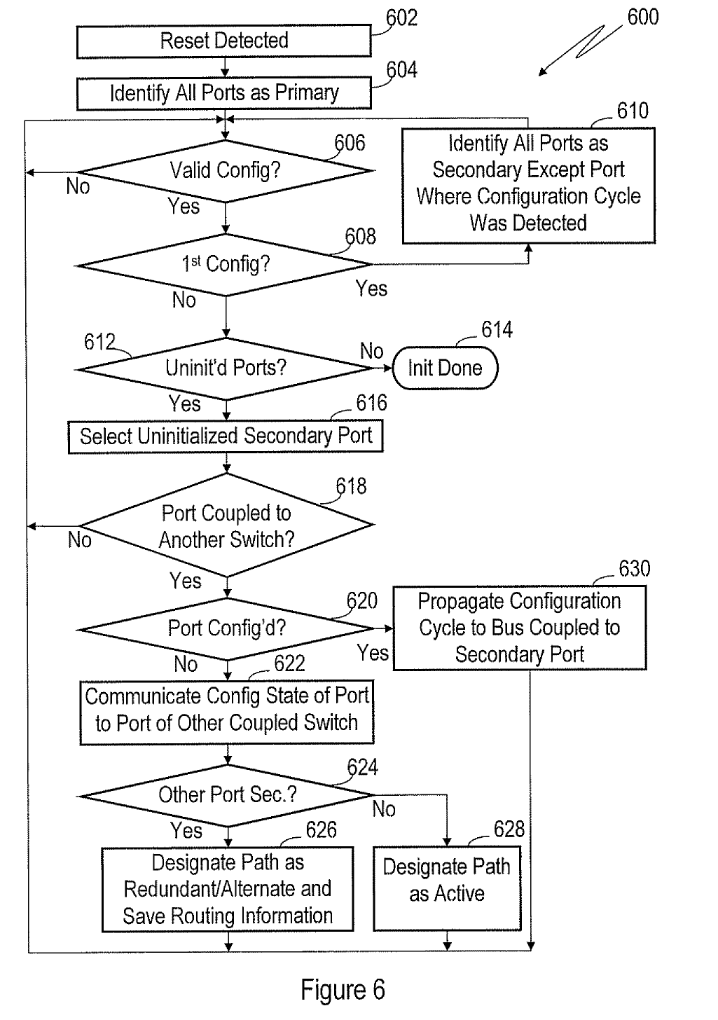

FIG. 6 illustrates initialization method 600 usable in a switch built in accordance with at least some illustrative embodiments. After the switch detects a reset in block 602 all the ports of the switch are identified as primary ports as shown in block 604. A wait state is entered in block 606 until the switch detects a valid configuration cycle. If the detected configuration cycle is the first valid configuration cycle (block 608), the switch identifies as secondary all ports other than the port on which the configuration cycle was detected, as shown in block 610.

After processing the first valid configuration cycle, subsequent valid configuration cycles may cause the switch to initialize the remaining uninitialized secondary ports on the switch. If no uninitialized secondary ports are found (block 612) the initialization method 600 is complete (block 614). If an uninitialized secondary port is targeted for enumeration (blocks 612 and 616) and the targeted secondary port is not coupled to another switch (block 618), no further action on the selected secondary port is required (the selected secondary port is initialized).

If the secondary port targeted in block 616 is coupled to a subordinate switch (block 618) and the targeted secondary port has not yet been configured (block 620), the targeted secondary port communicates its configuration state to the port of the subordinate switch to which it couples (block 622). If the port of the subordinate switch is also a secondary port (block 624) the path between the two ports is designated as a redundant or alternate path and routing information associated with the path (e.g., bus segment numbers) is exchanged between the switches and saved (block 626). If the port of the subordinate switch is not a secondary port (block 624) the path between the two ports is designated as an active path (block 628) using PCI routing. The subordinate switch then toggles all ports other than the active port to a redundant/alternate state (i.e., toggles the ports, initially configured by default as primary ports, to secondary ports). After configuring the path as either active or redundant/alternate, the port is configured and the process is repeated by again waiting for a valid configuration cycle in block 606

When all ports on all switches have been configured, the hierarchy of the bus is fully enumerated. Multiple configuration cycles may be needed to complete the initialization process. After a selected secondary port has been initialized, the process is again repeated for each port on the switch and each of the ports of all subordinate switches.

Once the initialization process has completed and the computer system begins operation, data packets may be routed as needed through alternate paths identified during initialization. For example, referring again to FIG. 5, when a data packet is sent by management node 122 to I/O node 126, it is routed from port 36 to port 34 of switch 116. But if switch 116 were to fail, management node 122 would then attempt to send its data packet through switch 114 (via the node's secondary path to that switch). Without switch 116, however there is no remaining active path available and an alternate path must be used. When the data packet reaches switch 114, the extended information stored in the switch (e.g., routing table information such as the nearest bus segment number) indicates that port 23 is coupled to a switch that is part of an alternate path leading to I/O node 126. The data packet is then routed to port 23 and forwarded to switch 110. Each intervening switch then repeats the routing process until the data packet reaches its destination

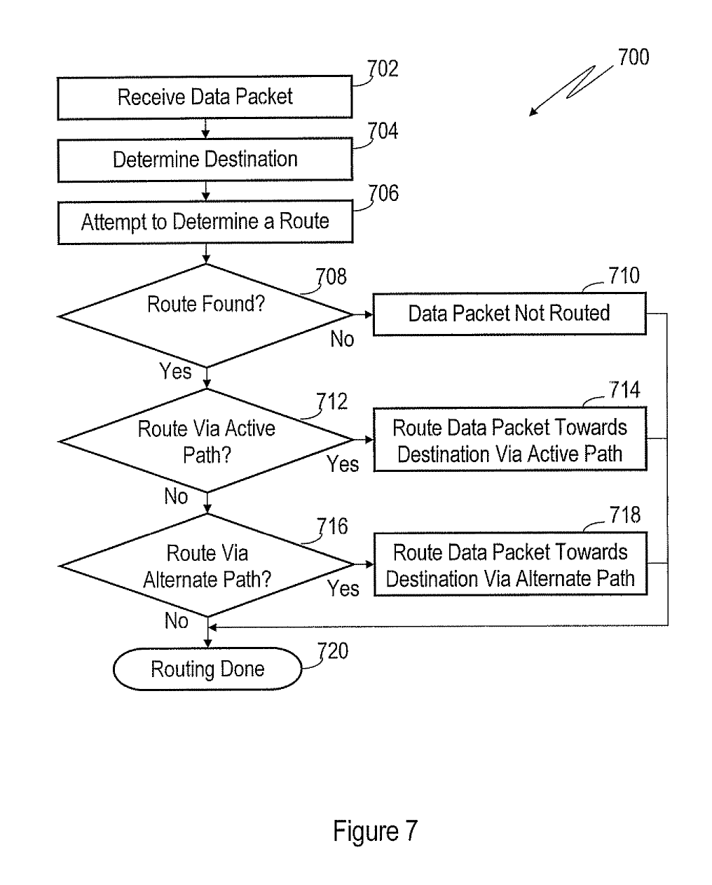

FIG. 7 illustrates routing method 700 usable in a switch built in accordance with at least some embodiments. The switch receives a data packet in block 702, and determines the destination of the data packet in block 704. This determination may be made comparing routing information stored in the switch with the destination of the data packet. The routing information may describe which busses and devices are accessible through a particular port (e.g., segment numbers within the PCI bus architecture), Based on the destination, the switch attempts to determine a route to the destination through the switch (block 706). If a route is not found (block 708), the data packet is not routed (block 710). It should be noted that a packet should always be routable, and a failure to route a packet is considered an exception condition that is intercepted and handled by the management node. If a route is found (block 708) and the determined route is through an active path (block 712), then the data packet is routed towards the destination through the identified active path (block 714). If a route is found and the determined route is through an alternate path (block 716), then the data packet is routed towards the destination through the identified alternate path (block 718). After determining the path of the route (if any) and routing the data packet (if possible), routing is complete (block 720).

By adapting a rooted hierarchical interconnect bus to operate as a network switch fabric as described above, the various nodes coupled to the network switch fabric can communicate with each other at rates comparable to the transfer rates of the internal busses within the nodes. By providing high performance end-to-end transfer rates across the network switch fabric, different nodes interconnected to each other by the network switch fabric, as well as the individual component devices within the nodes, can be combined to form high-performance virtual machines. These virtual machines are created by implementing abstraction layers that combine to form virtual structures such as, for example, a virtual bus between a CPU on one node and a component device on another node, a virtual multiprocessor interconnect between shared devices and multiple CPUs (each on separate nodes), and one or more virtual networks between CPUs on separate nodes

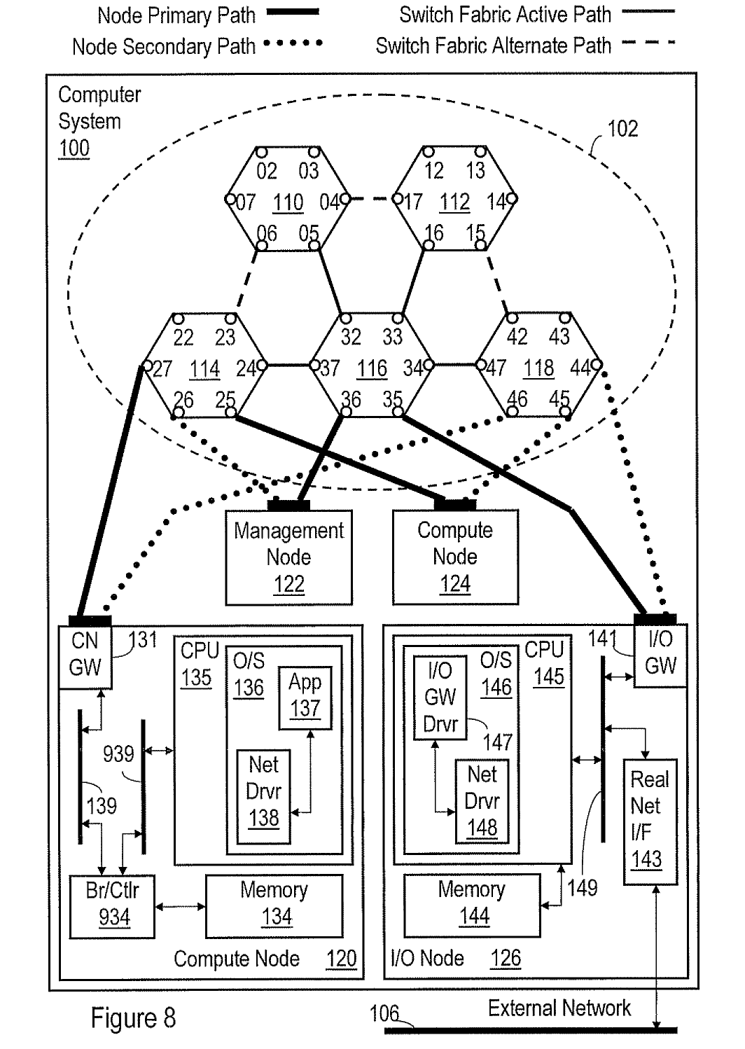

FIG. 8 shows an illustrative embodiment that may be configured to implement a virtual machine over a virtual bus. Compute node 120 comprises CPU 135 and bridge/memory controller (Br/Ctlr) 934 (e.g., a North Bridge), each coupled to front-side bus 939; compute node gateway (CN GW) 131, which together with bridge/memory controller 934 is coupled to internal bus 139 (e.g., a PCI bus); and memory 134 which is coupled to bridge/memory controller 934. Operating system (O/S) 136, application program (App) 137, and network driver (Net Drvr) 138 are software programs that execute on CPU 135, Both application program 137 and network driver 138 execute within the environment created by operating system 136, I/O node 126 similarly comprises CPU 145, I/O gateway 141, and real network interface (Real Net I/F) 143, each coupled to internal bus 149, and memory 144 which couples to CPU 145 O/S 146 executes on CPU 145, as does I/O gateway driver (I/O GW Drvr) 147 and network driver 148, both of which execute within the environment created by O/S 146.

Compute node gateway 131 and I/O gateway 141 each acts as an interface to network switch fabric 102, and each provides an abstraction layer that allows components of each node to communicate with components of other nodes without having to interact directly with the network switch fabric 102. Each gateway described in the illustrative embodiments disclosed comprises a controller that implements the aforementioned abstraction layer The controller may comprise a hardware state machine, a CPU executing software, or both. Further, the abstraction layer may be implemented as hardware and/or software operating within the gateway alone, or may be implemented as gateway hardware and/or software operating in concert with driver software executing on a separate CPU Other combinations of hardware and software may become apparent to those skilled in the art, and the present disclosure is intended to encompass all such combinations.

An abstraction layer thus implemented allows individual components on one node (e.g., I/O node 126) to be made visible to another node (e.g., compute node 120) as virtual devices The virtualization of a physical device or component allows the node at the root level of the resulting virtual bus (described below) to enumerate the virtualized device within the virtual hierarchical bus. As part of the abstraction layer, the virtualized device may be implemented as part of I/O gateway 141, or as part of a software driver executing within CPU 145 of 110 node 126 (e.g., I/O gateway driver 147).

By using an abstraction layer, the individual components (or their virtualized representations) do not need to be capable of directly communicating across network switch fabric 102 using the underlying protocol of the hierarchical bus of network switch fabric 102 (managed and enumerated by management node 122) Instead, each component formats outgoing transactions according to the protocol of the internal bus (139 or 149) and the corresponding gateway for that node (131 or 141) encapsulates the outgoing transactions according to the protocol of the underlying rooted hierarchical bus protocol of network switch fabric 102. Incoming transactions are similarly unencapsulated by the corresponding gateway for a node.

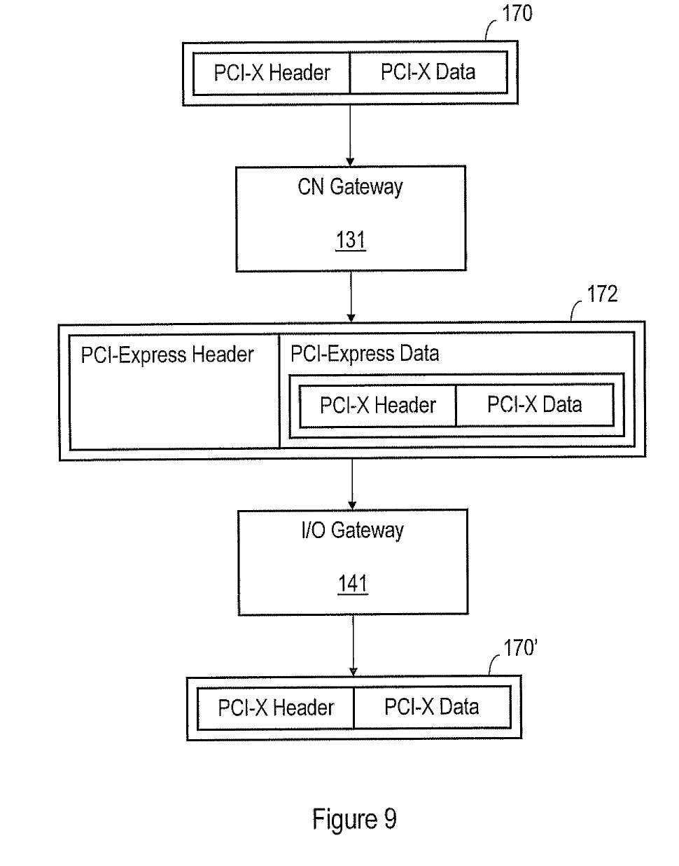

Referring to the illustrative embodiments of FIGS. 8 and 9, if CPU 135 of compute node 120 is sending data to external network 106 via real network interface 143 of I/O node 126, CPU 135 presents the data to network driver 138. Network driver 138 forwards the data to compute node gateway 131 according to the protocol of internal bus 139, for example, as PCI-X® transaction 170. PCI-X® transaction 170 is encapsulated by compute node gateway 131, which forms a transaction formatted according to the underlying rooted hierarchical bus protocol of network switch fabric 102, for example, as PCI Express® transaction 172. Network switch fabric 102 routes PCI Express®D transaction 172 to I/O node 126, where I/O node gateway 141 and I/O gateway driver 147 combine to extract the original unencapsulated transaction 170′. A virtualized representation of real network interface 143 (described below) made visible by I/O gateway driver 147 and I/O gateway 141 processes, formats, and forwards the original unencapsulated transaction 170′ to external network 106 via network driver 148 and real network interface 143.

It should be noted that although the encapsulating protocol is different from the encapsulated protocol in the example described, it is possible for the underlying protocol to be the same protocol for both. Thus for example, both the internal busses of compute node 120 and I/O node 126 and the network switch fabric may all use PCI Express® as the underlying protocol In such a configuration, the abstraction still serves to hide the existence of the underlying hierarchical bus of the network switch fabric 102, allowing selected components of the compute node 120 and the I/O node 126 to interact as if communicating with each other over a single bus or point-to-point interconnect Further, the abstraction layer observes the packet or message ordering rules of the encapsulated protocol. Thus, for example, if a message is sent according to an encapsulated protocol that does not guarantee delivery or packet order, the non-guaranteed delivery and out-of-order packet rules of the encapsulated protocol will be implemented by both the transmitter and receiver of the packet, even if the underlying hierarchical bus of network switch fabric 102 follows ordering rules that are more stringent (e.g., guaranteed delivery and all packets kept in a first-in/first-out order). Those skilled in the art will appreciate that many other quality of service (QoS) rules (e.g., error detection/correction, connection management, bandwidth allocation, and buffer allocation rules) may be implemented by the gateways of the illustrative embodiments described. Such quality of service rules may be implemented either as part of the protocol emulated, or as additional quality of service rules implemented transparently by the gateways. All such rules and implementations are intended to be within the scope of the present disclosure.

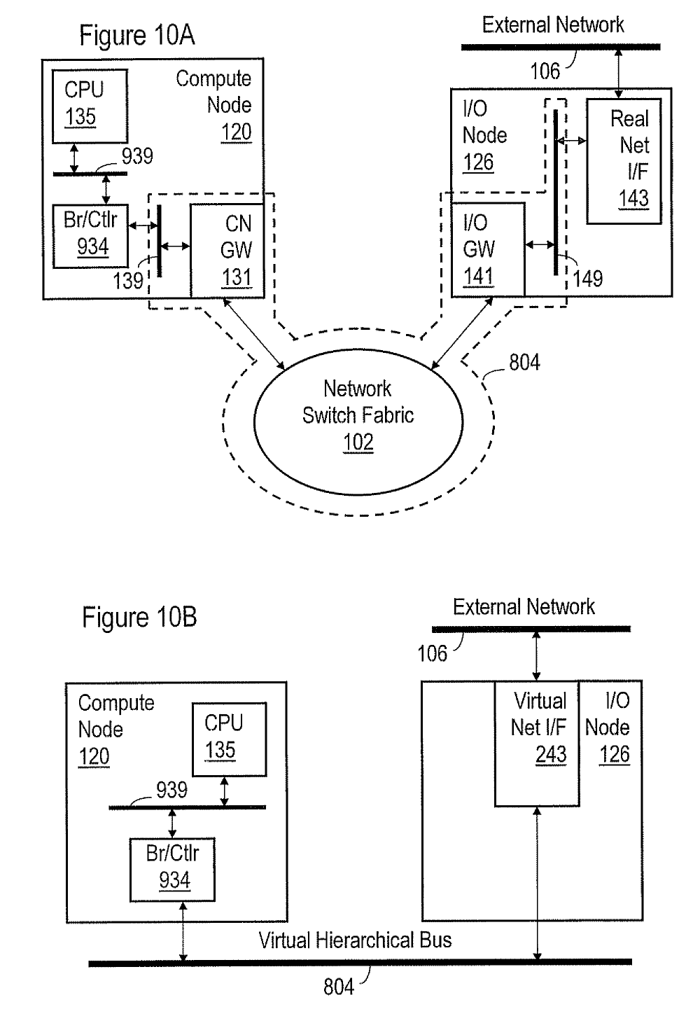

The encapsulation and abstraction provided by compute node gateway 131 and I/O gateway 141 are performed transparently to the rest of the components of each of the corresponding nodes. As a result, CPU 135 and the virtualized representation of real network interface 143 (e.g., virtual network interface 243) each behave as if they were communicating across a single virtual bus 804, as shown in FIGS. 10A and 10B. Because the gateways encapsulate and unencapsulate transactions as they are sent and received, and because the underlying rooted hierarchical bus of network switch fabric 102 has a level of performance comparable to that of internal busses 139 and 149, little delay is added to bus transactions as a result of the encapsulation and unencapsulation of internal native bus transactions. Also, because internal busses 139 and 149 require no modification, existing components (e.g., CPUs and network interfaces) may be used within the system without the need for hardware modifications or special software drivers. The existence of the gateways and the functionality they provide is invisible to the rest of the hardware, as well as to operating systems 136 and 146 executing on the CPUs of nodes 120 and 126 respectively (see FIG. 8).

Although the gateways can operate transparently to the rest or the system (e.g., when providing a path between CPU 135 and virtual network interface 243 of FIG. 10B), it is also possible for the gateways to emulate other devices when providing a virtualized extension of the internal interconnect of one or more nodes. For example, a gateway may emulate a bus bridge in a multi-drop interconnect configuration (e.g., PCI), as well as a switch in a network or point-to-point interconnect configuration (e.g., PCI-Express, small computer system interface (SCSI), serial attached SCSI (SAS), Internet SCSI (iSCSI) Ethernet, Fibre Channel and lnfiniband®). Also, a gateway may be configured for either transparent operation or device emulation operation when implementing a virtualized interconnect that supports processor coherent protocols, such as the HyperTransport™, Common System Interconnect, and Front Side Bus protocols Thus, when implementing these protocols, the gateways may be configured to either not be visible to the operating system (e.g., by emulating a point-to-point HyperTransport™ connection between CPU 135 and CPU 155), or alternatively configured to appear as bridging devices (e.g., by emulating a HyperTransport™ bridge or tunnel). Many other gateway emulation configurations will become apparent to those skilled in the art, and all such configurations are intended to be within the scope of the present disclosure.

Each gateway allows virtualized representations of selected devices within one node to appear as endpoints within the bus hierarchy of another node Thus, for example, virtual network interface 243 of FIG. 10B appears as an endpoint within the bus hierarchy of compute node 120, and is accordingly enumerated by compute node 120. The real device (e.g., real network interface 143) continues to be an enumerated device within the internal bus of the node which the device is a part of (e.g., I/O node 126 for real network interface 143). The gateway itself appears as an endpoint within the underlying bus hierarchy of the network switch fabric 102 (managed and enumerated by management node 122 of FIG. 8).

For example, if I/O node 126 of FIG. 8 initializes I/O gateway 141 after the network switch fabric 102 has been initialized and enumerated by management node 122 as previously described, I/O gateway 141 will generate a plug-and-play event on the underlying PCI Express® bus of the network switch fabric 102. The management node 122 will respond to the event by enumerating I/O gateway 141, thus treating it as a new endpoint. During the enumeration, management node 122 obtains and stores information about virtual network interface 243 (the virtualized version of real network interface 143 of FIG. 8) exposed by I/O gateway 141. Subsequently, the management node 122 can associate virtual network interface 243 with a host. For example, virtual network interface 243 is associated with compute node 120 in FIG. 10B.

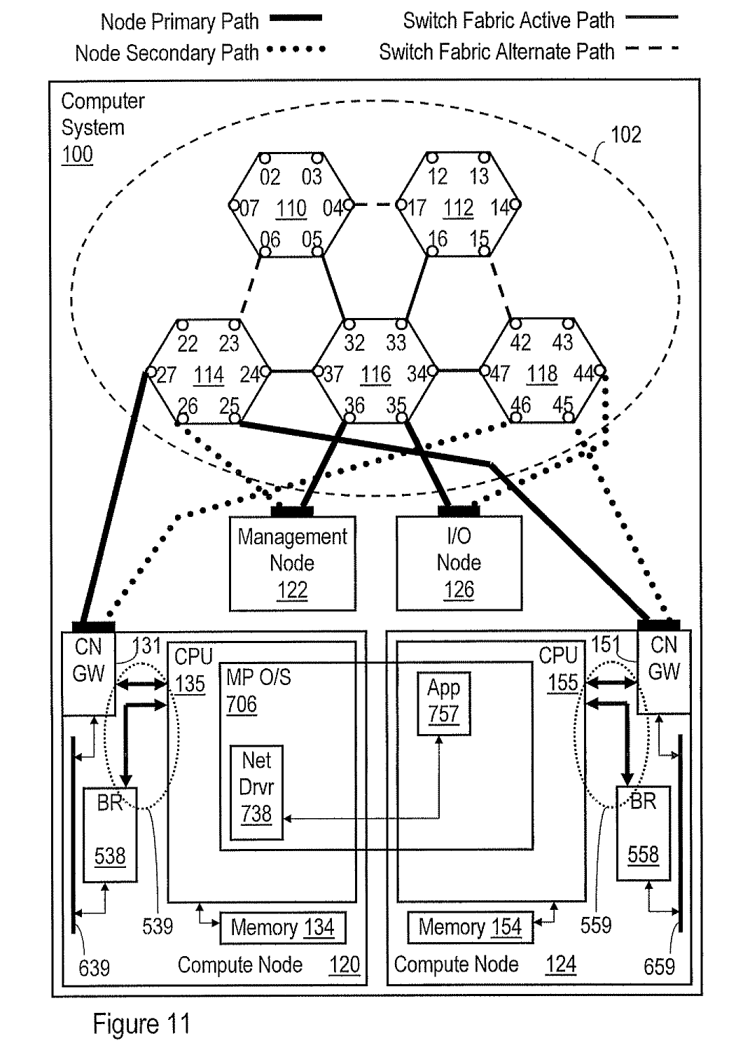

In the illustrative embodiment of FIGS. 10A and 10B the virtual bus implemented utilizes the same architecture and protocol as internal busses 139 and 149 of compute node 120 and I/O node 126 (e.g., PCI). In other illustrative embodiments, the architecture and protocol of the virtual bus may be different from both the underlying internal busses of the nodes and the underlying network switch fabric 102. This permits the implementation of features beyond those of the native busses and switch fabrics within computer system 100. Referring to the illustrative embodiment of FIG. 11, compute nodes 120 and 124 may each operate as a single virtual machine, even though the underlying hierarchical bus of the network switch fabric that couples the nodes to each other does not support multiprocessor operation

Compute node 120 of FIG. 11 is similar to compute node 120 of FIG. 8, with the addition of point-to-point multiprocessor interconnect 539 (e.g., a HyperTransport™-based interconnect). CPU 135 couples to memory 134, compute node gateway 131, and bridge (BR) 538. Bridge 538 also couples to hierarchical bus 639, providing any necessary bus and protocol translations (e.g., HyperTransport™-to-PCI and PCI-to-HyperTransport™) Because it couples to both point-to-point multiprocessor interconnect 539 and hierarchical bus 639, compute node gateway 131 allows extensions of either to be virtualized via the gateway. Compute node 124 is also similar to compute node 120 of FIG. 8, comprising CPU 155, hierarchical bus 659, point-to-point multiprocessor interconnect 559, memory 154, bridge 558, and compute node gateway (CN GW) 151. Bridge 558 couples point-to-point multiprocessor interconnect 559 to hierarchical bus 659, and both the hierarchical bus and the point-to-point multiprocessor interconnect are coupled to compute node gateway 151,

Multiprocessor operating system (MP O/S) 706, application program (App) 757, and network driver (Net Drvr) 738 are software programs that execute on CPUs 135 and 155. Application program 757 and network driver 738 each operate within the environment created by multiprocessor operating system 706. Multiprocessor operating system 706 executes on the virtual multiprocessor machine created as described below, allocating resources and scheduling programs for execution on the various CPUs as needed, according to the availability of the resources and CPUs. For example, FIG. 11 shows network driver 738 executing on CPU 135, and application program 757 executing on CPU 155, but other distributions are possible, depending on the availability of the CPUs. Further, individual applications may be executed in a distributed manner across both CPU 135 and CPU 155 through the use of multiple execution threads, each thread executed by a different CPU. Access to network driver 738 may also be scheduled and controlled by multiprocessor operating system 706, making it available as a single resource within the virtual multiprocessor machine. Many other implementations and combinations of multiprocessor operating systems, schedulers and resources, as well as multithreaded application programs, will become apparent to those skilled in the art, and all such implementations and combinations are intended to be within the scope of the present disclosure.

Compute node gateways 131 and 151 each acts as an interface to network switch fabric 102, and each provides an abstraction layer that allows the CPUs on nodes 120 and 124 to interact with each other without interacting directly with network switch fabric 102. Each gateway of the illustrative embodiment shown comprises a controller that implements the aforementioned abstraction layer. These controllers may comprise a hardware state machine, a CPU executing software, or both. Further, the abstraction layer may be implemented by hardware and/or software operating within the gateway alone or may be implemented as gateway hardware and/or software operating in concert with hardware abstraction layer (HAL) software executing on a separate CPU. Other combinations of hardware and software may become apparent to those skilled in the art, and the present disclosure is intended to encompass all such combinations.

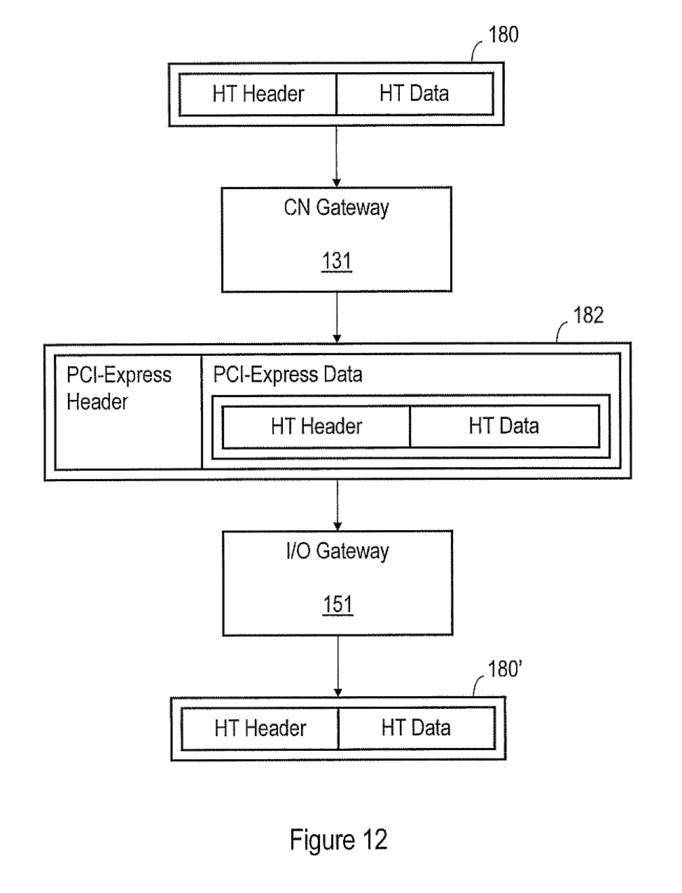

An abstraction layer thus implemented allows the CPUs on each node to be visible to one another as processors within a single virtual multiprocessor machine, and serves to hide the underlying rooted hierarchical bus protocol of the network switch fabric. Referring to FIGS. 11 and 12, if CPU 135 of compute node 120 initiates a transaction destined to a resource within the virtual multiprocessor machine, a native point-to-point multiprocessor interconnect transaction within compute node 120 (e.g., HyperTransport™ (HT) transaction 180) is received by compute node gateway 131. The transaction is encapsulated according to the underlying rooted hierarchical bus protocol of network switch fabric 102. The encapsulation process also serves to translate the identification information or device identifiers within the transaction (e.g., a point-to-point multiprocessor interconnect end-device identifier) into corresponding rooted hierarchical bus end-device identifiers as assigned by the enumeration process previously described for network switch fabric 102.

The transaction is made visible to CPU 155 on compute node 124 by compute node gateway 151, which unencapsulates the point-to-point multiprocessor interconnect transaction (e.g., HT transaction 180′ of FIG. 12), and translates the end-device information Thus, for example, if CPU 135 sends a point-to-point multiprocessor interconnect transaction to CPU 155, compute node gateway 151 will unencapsulate and translate the point-to-point multiprocessor interconnect transaction, and present it to CPU 155 via internal point-to-point multiprocessor interconnect 559. Such a transaction may be used, for example, to coordinate the execution of multiple threads within an application, or to coordinate the allocation and use of shared resources within the multiprocessor environment created by the virtualized multiprocessor machine.

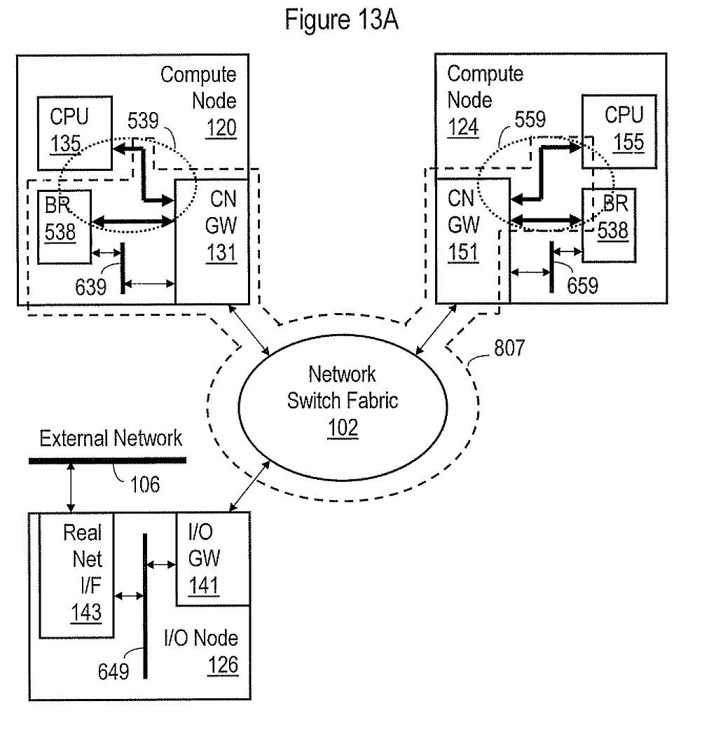

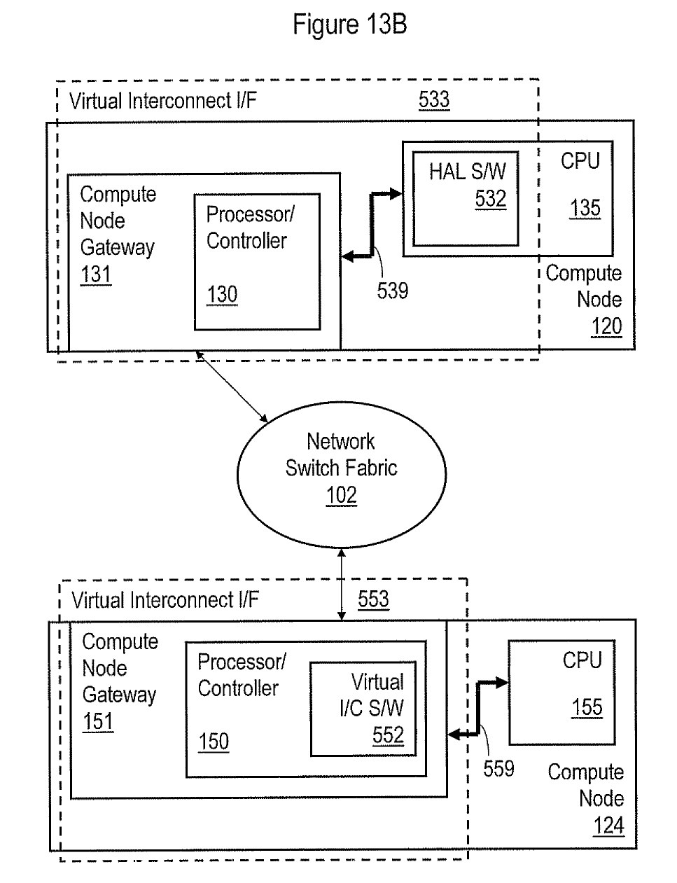

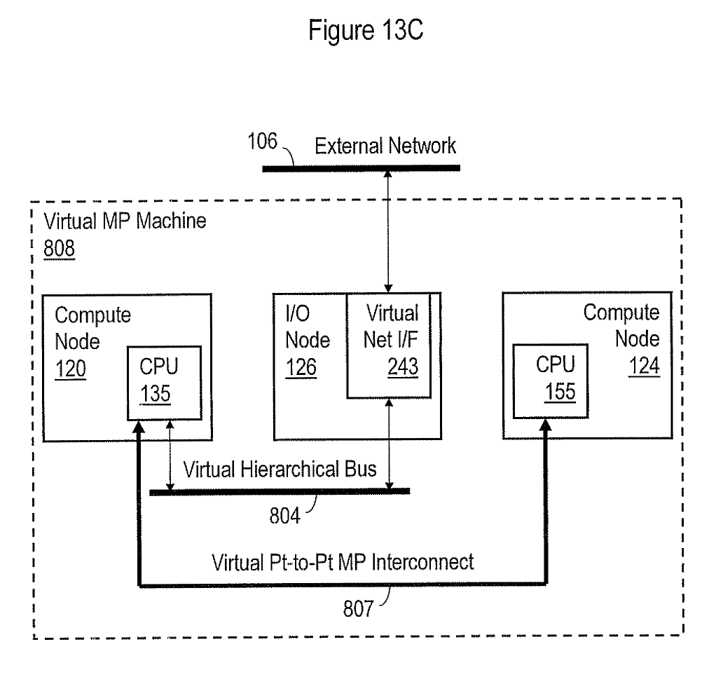

FIGS. 13A and 13B illustrate how such a virtual multiprocessor machine is created. As with the virtual bus described above, compute node gateway 131, compute node gateway 151, and I/O node gateway 141 of FIG. 13A each provide an abstraction layer that hides the underlying hierarchical structure of network switch fabric 102 from compute node 120, compute node 124 and I/O node 126. When operating in this manner to virtualize the connection between two hosts, the gateways on each host appear to each corresponding CPU as a single virtual interface to a virtual point-to-point multiprocessor interconnect

FIG. 13B illustrates two embodiments of a compute node that each virtualizes the interface to network switch fabric 102, making the switch fabric appear as a virtual point-to-point multiprocessor interconnect between the compute nodes. The illustrative embodiment of compute node 120 comprises CPU 135 and compute node gateway 131, each coupled to the other via point-to-point multiprocessor interconnect 539. Compute node gateway 131 couples to network switch fabric 102, and comprises processor/controller 130, Hardware abstraction layer software (HAL SNV) 532 is a program that executes on CPU 135, and which provides an interface to compute node gateway 131 that causes the gateway to appear as an interface to a point-to-point multiprocessor interconnect (e.g., a HypterTransport™-based interconnect) Hardware abstraction layer software 532 interacts with processor/controller 130, which encapsulates and/or unencapsulates point-to-point multiprocessor interconnect transactions, provided by and/or to hardware abstraction layer software 532, according to the protocol of the underlying bus architecture of network switch fabric 102 (e.g., PCI Express®). The encapsulated transactions are transmitted across network switch fabric 102 to a target node, and/or received from a source node (erg, compute node 124). In this manner hardware abstraction layer software 532, processor/controller 130, and compute node gateway 131 are combined to create virtual interconnect interface (Virtual Interconnect I/F) 533.

Continuing to refer to FIG. 13B, compute node 124 illustrates another embodiment of a compute node that virtualizes the interface to network switch fabric 102 to create a virtual point-to-point multiprocessor interconnect and bus interface. Compute node 124 comprises CPU 155 and compute node gateway 151, each coupled to the other via point-to-point multiprocessor interconnect 559. Compute node gateway 151 couples to network switch fabric 102, and comprises processor/controller 150. Compute node 124 comprises virtual interconnect software (Virtual I/C SAN) 552, which unlike the embodiment of compute node 120 executes on processor/controller 150 of compute node gateway 151, Virtual interconnect software 552 causes processor/controller 150 to encapsulate and transmit point-to-point multiprocessor interconnect transactions to a target node, and/or unencapsulate received point-to-point multiprocessor interconnect transactions from a source node, across network switch fabric 102. The encapsulation and unencapsulation of transactions is again implemented by processor/controller 150 according to the protocol of the underlying bus architecture of network switch fabric 102. The combination of virtual interconnect software 552, processor/controller 150, and compute node gateway 151 thus results in the creation of virtual interconnect interface (Virtual Interconnect I/F) 553.

FIG. 13C illustrates an embodiment wherein virtual point-to-point multiprocessor interconnect 807 and virtual multiprocessor machine 808 are created as described above. CPUs 135 and 155 of compute nodes 120 and 124, and virtual network interface 243 within I/O node 126 operate together as a single virtual multiprocessor machine. The virtual multiprocessor machine is created and operated within the system according to the multiprocessor interconnect protocol that is virtualized, even though multiprocessor operation is not supported by the native PCI protocol of the switch fabric. Further, virtual hierarchical busses may concurrently be created across the same network switch fabric to support additional virtual extensions within the virtual machine, such as, for example, virtual hierarchical bus 804 of FIG. 13C, used to couple virtual network interface 243 within I/O node 126 to CPU 135.

Although the illustrative embodiment of FIG. 13C implements a virtual point-to-point multiprocessor interconnect (Virtual Pt-to-Pt MP Interconnect 807), any of a variety of bus architectures and protocols that support multiprocessor operation may be implemented These may include, for example, point-to-point bus architectures and protocols (e.g., the HyperTransport™ architecture and protocol by AMD®, and the Common System Interconnect (CSI) architecture and protocol by Intel®), as well as multi-drop, coherent processor protocols (e.g., the Front Side Bus architecture and protocol by Intel®). Many other architectures and protocols will become apparent to those skilled in the art, and all such architectures and protocols are intended to be within the scope of the present disclosure.

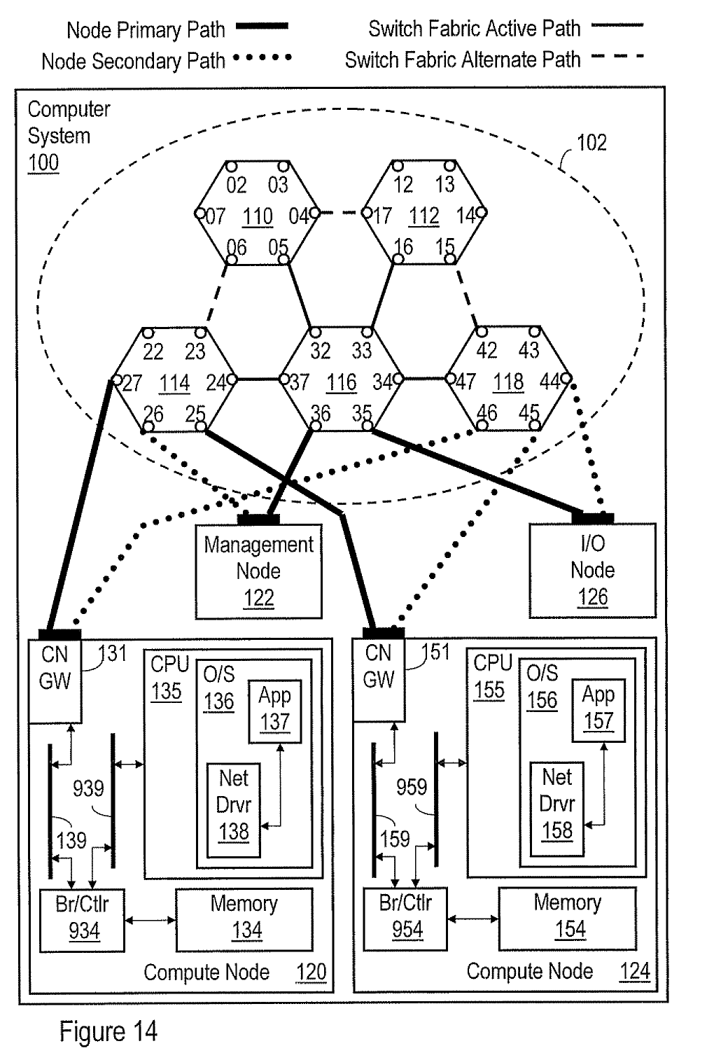

The network switch fabric also supports the creation of one or more virtual networks between virtual machines. FIG. 14 shows two compute nodes configured to support such a virtual network, in accordance with at least some illustrative embodiments Compute node 120 of FIG. 14 is similar to compute node 120 of FIG. 8, comprising CPU 135 and bridge/memory controller (Br/Ctlr) 934, each coupled to front-side bus 939, compute node gateway (CN GW) 131, which together with bridge/memory controller 934 is coupled to internal bus 139, and memory 134 which is coupled to bridge/memory controller 934. O/S 136 executes on CPU 135, as does application software (App) 137 and network driver 138, both of which execute within the environment created by O/S 146. Compute node 124 of FIG. 14 is also similar to compute node 120 of FIG. 8, comprising CPU 155 and bridge/memory controller (Br/Ctlr) 954, each coupled to front-side bus 959; compute node gateway 151, which together with bridge/memory controller 934 is coupled to internal bus 159, and memory 154 which is coupled to bridge/memory controller 954. O/S 156 executes on CPU 155, as does application software (App) 137 and network driver (Net Drvr) 138, both of which execute within the environment created by O/S 146,

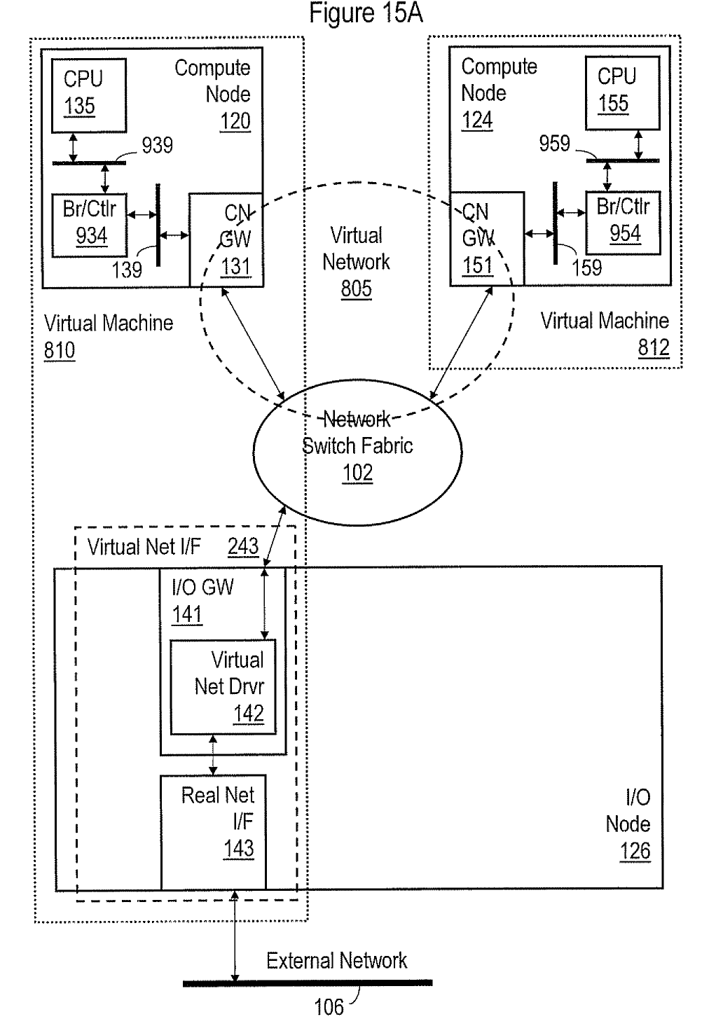

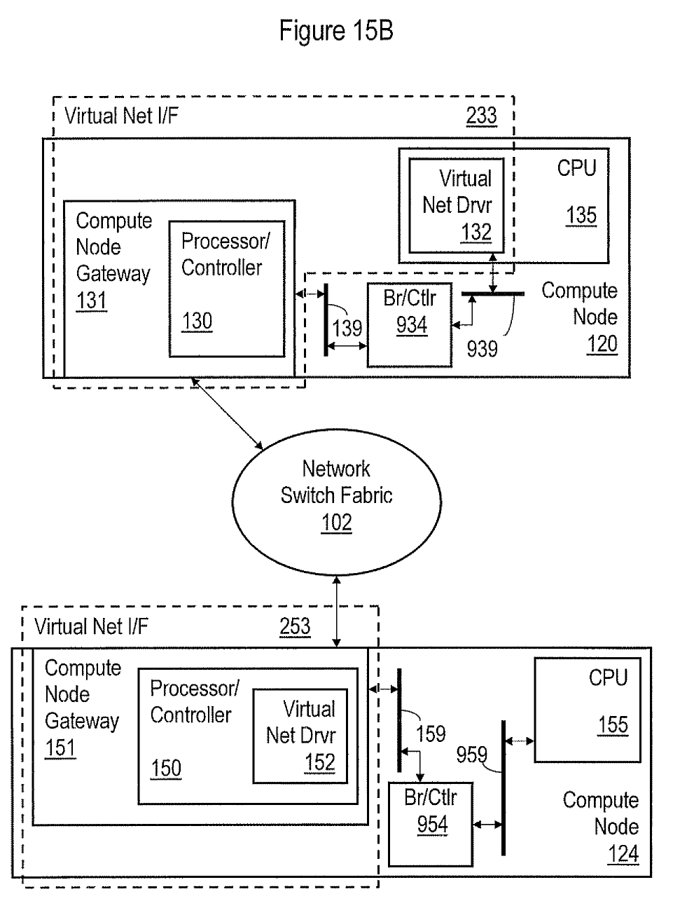

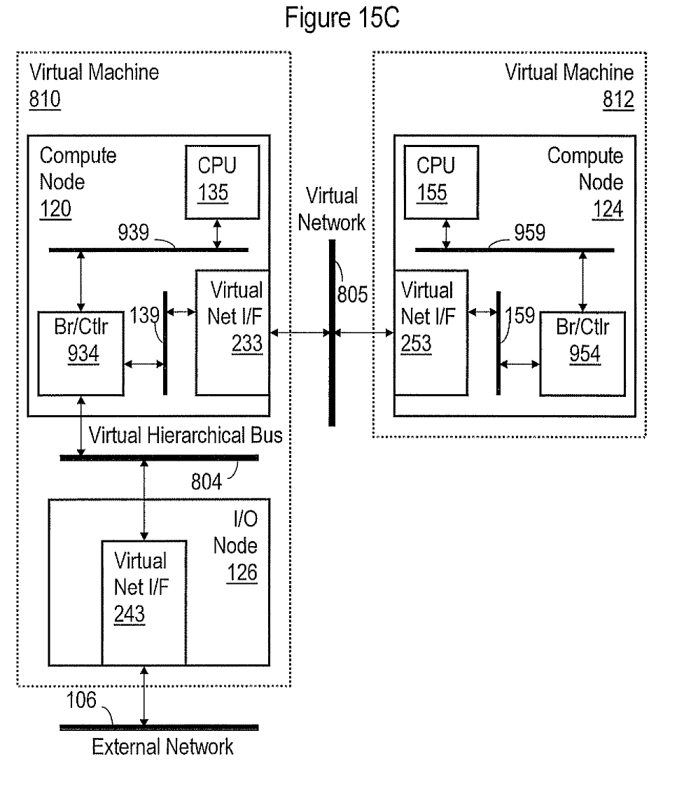

FIGS. 15A and 15B illustrate how a virtual network is created between compute nodes 120 and 124 of FIG. 14. As with the virtual bus described above, compute node gateway 131 and compute node gateway 151 of FIG. 15A each provide an abstraction layer that hides the underlying hierarchical structure of network switch fabric 102 from both compute node 120 and compute node 124. However, when operating in this manner to virtualize the connection between two hosts, the gateways on each host appear to each corresponding CPU as a virtual network interface to a virtual network, rather than as a virtual bus bridge to a virtual bus as previously described

FIG. 15B illustrates two embodiments of a compute node that each virtualizes the interface to network switch fabric 102, making the switch fabric appear as a virtual network between the compute nodes. The illustrative embodiment of compute node 120 comprises CPU 135 and compute node gateway 131, each coupled to internal bus 139. Compute node gateway 131 couples to network switch fabric 102, and comprises processor/controller 130. Virtual network driver (Virtual Net Drvr) 132 is a network driver program that executes on CPU 135, and which provides an interface to compute node gateway 131 that causes the gateway to appear as an interface to a network (e.g., a TCP/IP network) Virtual network driver 132 interacts with processor/controller 130, which encapsulates and/or unencapsulates network messages, provided by and/or to virtual network driver 132, according to the protocol of the underlying bus architecture of network switch fabric 102 (e.g., PCI Express®). The encapsulated network messages are transmitted across network switch fabric 102 to a target node, and/or received from a source node (e.g., compute node 124). In this manner virtual network driver 132, processor/controller 130, and compute node gateway 131 are combined to create virtual network interface (Virtual Net I/F) 233.

Continuing to refer to FIG. 15B, compute node 124 illustrates another embodiment of a compute node that virtualizes the interface to network switch fabric 102 to create a virtual network and network interface. Compute node 124 comprises CPU 155 and compute node gateway 151, each coupled to internal bus 159. Compute node gateway 151 couples to network switch fabric 102, and comprises processor/controller 150. Compute node 124 also comprises a virtual network driver (152), but unlike the embodiment of compute node 120, virtual network driver 152 of the embodiment of compute node 124 executes on processor/controller 150 of compute node gateway 151. Virtual network driver 152 also causes processor/controller 150 to encapsulate and transmit network messages to a target node, and/or unencapsulate received network messages from a source node, across network switch fabric 102. The encapsulation and unencapsulation of network messages is again implemented by processor/controller 150 according to the protocol of the underlying bus architecture of network switch fabric 102. The combination of virtual network driver 152, processor/controller 150, and compute node gateway 151 thus results in the creation of virtual network interface 253.

FIG. 15C illustrates an embodiment wherein a virtual bus and a virtual network are both created as previously described. Virtual machine 810 includes compute node 120 and real network interface 143 (FIG. 8), virtualized and incorporated into virtual machine 810 as virtual network interface 243, via virtual bus 804. Virtual machine 812 includes compute node 124, and couples to virtual machine 810 via virtual network 805. Virtual network 805 is an abstraction layer created by compute node gateway 131 and compute node gateway 151 (FIG. 14) and visible to CPU 135 and CPU 155 as virtual network interfaces 233 and 253 respectively (FIG. 15C). As with virtual bus 804, the abstraction layer that creates virtual network 805 may be implemented by hardware and/or software operating within the gateways alone or may be implemented as gateway hardware and/or software operating in concert with driver software executing on separate CPUs within each compute node. Other combinations of hardware and software may become apparent to those skilled in the art, and the present disclosure is intended to encompass all such combinations.

Referring again to the illustrative embodiment of FIG. 14, compute nodes 120 and 124 may each operate as separate, independent computers, even though they share a common network switch fabric The two nodes can communicate with each other as if they were linked together by a virtual network (e.g., a TCP/IP network over Ethernet or over InfinBand), despite the fact that the nodes are actually coupled by the underlying bus interconnect of the network switch fabric 102. By appearing as just another network, existing network mechanisms within the operating systems of the compute nodes may be used to transfer the data. For example, if application program 137 (executing on CPU 135 within compute node 120), needs to transfer data to application program 157 (executing on CPU 155 within computer node 124), the application program uses existing network transfer mechanisms, such as, for example, a UNIX socket mechanism. The application program 137 obtains a socket from the operating system and then populates the associated socket structure with all the relevant information needed for the transfer (e.g., IP address, port number, data buffer pointers, and transfer type).

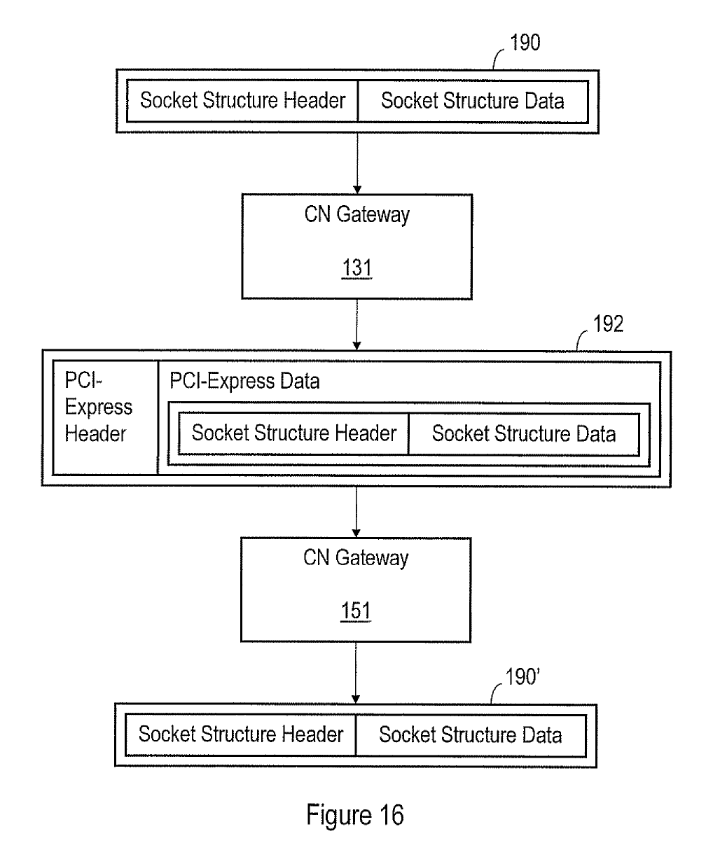

Once the socket structure has been populated, the application program 137 forwards the structure to the operating system 136 in a request to send data. Based on the network identification information within the socket structure (e.g., IP address and port), the operating system 136 routes the request to network driver 138, which has access to the network comprising the requested IP address This network, coupling compute node 120 and compute node 124 to each other as shown in FIG. 15C, is a virtual network (e.g., virtual network 805) that represents an abstraction layer that permits interoperability of the network switch fabric 102 with the existing network services provided by the operating system 135, Compute node gateway 131 forwards the populated socket structure data across the network switch fabric by translating the network identification information into corresponding rooted hierarchical bus end-device identifier information and encapsulating the data as shown in FIG. 16. The socket structure 190 (header and data) is encapsulated by compute node gateway 131 to form a transaction formatted according to the underlying rooted hierarchical bus protocol of network switch fabric 102, for example, as PCI Express® transaction 192. Network switch fabric 102 routes PCI Express® transaction 192 to compute node 124 (based upon the end-device identifier), where compute node gateway 151 extracts the original unencapsulated network message 190′ and forwards it to network driver 158 (FIG. 14). The received, unencapsulated network message 190′ is then forwarded and processed by application program 157 in the same manner as any other data received from a network interface.

As already noted, virtual network message transfers may be executed using the native data transfer operations of the underlying interconnect bus architecture (e.g., PCI). The enumeration sequence of the illustrative embodiments previously described identifies each node within the computer system 100 of FIG. 14 as an end-device, and associates a unique, rooted hierarchical bus end-device identifier with each node. The identifiers allow virtual network messages to be directed by the source to the desired end-device. Although the socket structures are configured as if the network messages are being transmitted using a network messaging protocol (e.g., TCP/IP) no additional encapsulation of the data is necessary for routing or packet reordering purposes. The network messaging protocol information is used to determine the routing of the network message, but the network message is not encapsulated or formatted according to the requested protocol, instead being encapsulated and transmitted as previously described (FIG. 16). This architecture allows the network drivers 138 and 158 to send and receive network messages at the full rate of the underlying interconnect, with less communication stack processing overhead than might be required if additional encapsulation were present.

Although the embodiments described utilize UNIX sockets as the underlying communication mechanism and TCP/IP as an example of a network messaging protocol that may form the basis of the transmitted network message, those skilled in the art will appreciate that other mechanisms and network messaging protocols may also be used. The present application is not intended to be limited to the illustrative embodiments described, and all such network communications mechanisms and protocols are intended to be within the scope of the present application. Further, the underlying network bus architecture is also not intended to be limited to PCI bus architectures. Different combinations of network communications mechanisms, network messaging protocols and bus architectures will thus also become apparent to those skilled in the art, and the present disclosure is intended to encompass all such combinations as well

The various virtualizations described (machines and networks), may be combined to operate concurrently over a single network switch fabric 102. For example, referring again to FIG. 8, compute node 120 may operate as a virtual machine that communicates with I/O node 126 using PCI transactions encapsulated by an underlying PCI Express® switch fabric 102. The same virtual machine may communicate with a second virtual machine (comprising compute node 124) over a virtual network using virtual TCP/IP network messages encapsulated by the same underlying PCI Express® network switch fabric 102.

It should be noted that although the encapsulation, abstraction and emulation provided by the gateways allows for data transfers at data rates comparable to the data rate of the underlying network switch fabric, the various devices and interconnects emulated need not operate at the full bandwidth of the underlying switch fabric. In at least some illustrative embodiments, the overall bandwidth of the switch fabric may be allocated among several concurrently emulated interconnects, devices, and or networks, wherein each emulated device and/or interconnect is limited to an aggregate data transfer rate below the overall data transfer rate of the network switch fabric. This limitation may be imposed by the gateway and/or software executing on the gateway or the CPU of the node that includes the gateway.

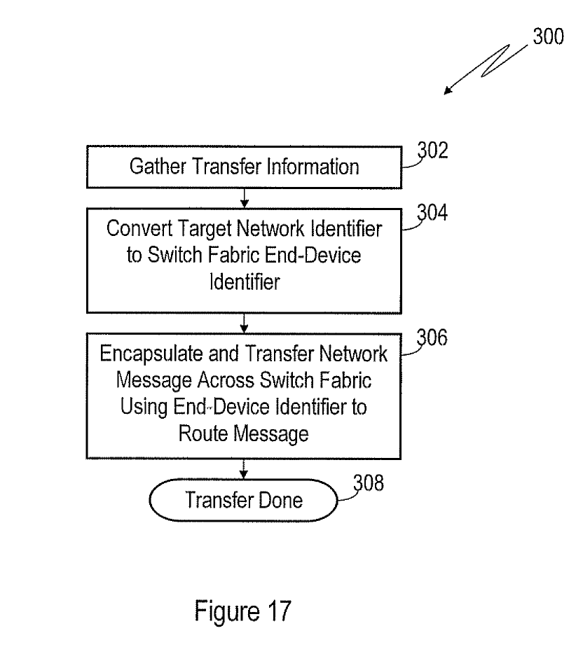

FIG. 17 illustrates a method 300 implementing a virtual network transfer mechanism over a hierarchical network switch fabric, in accordance with at least some embodiments. Information needed for the transfer of the data is gathered as shown in block 302. This may include a network identifier of a target node (e.g., a TCP/IP network address), the protocol of the desired transfer (e.g., TCP/IP), and the amount of data to be transferred. Once the information has been gathered, the network identifier of the target node is converted into a hierarchical bus end-device identifier (block 304). The hierarchical bus end-device identifier is the same identifier that was assigned to the target node during the enumeration process performed as part of the initialization of the network switch fabric 102 (see FIG. 8). Continuing to refer to FIG. 17, once the end-device identifier of the target node has been determined, the network message is encapsulated and transferred across the network switch fabric (block 306), after which the transfer is complete (block 308).

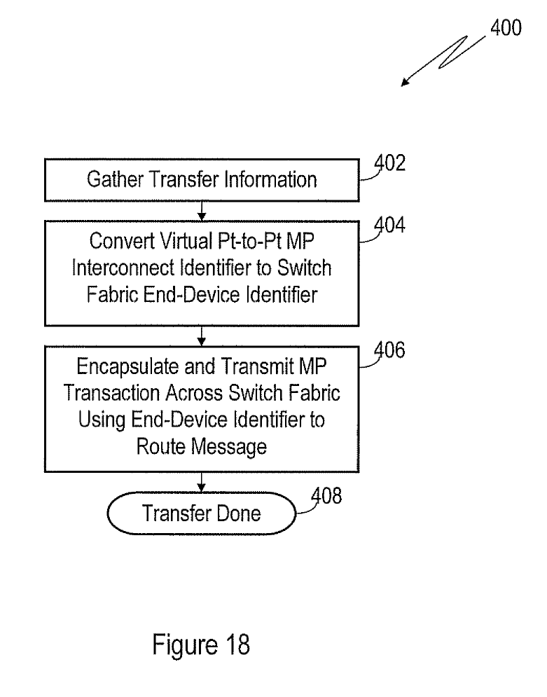

FIG. 18 illustrates a method 400 implementing a virtual multiprocessor interconnect transfer mechanism over a hierarchical network switch fabric, in accordance with at least some embodiments Information needed for the multiprocessor interconnect transactions is gathered as shown in block 402. This may include a virtual point-to-point multiprocessor interconnect identifier of a target resource (e.g., a HyperTransport™ bus identifier), the protocol of the desired transfer (e.g., HyperTransport™), and the amount of data to be transferred as part of the transaction. Once the information has been gathered, the virtual point-to-point multiprocessor interconnect identifier of the target resource is converted into a hierarchical bus end-device identifier (block 404). The hierarchical bus end-device identifier is the same identifier that was assigned to the remote node during the enumeration process performed as part of the initialization of the network switch fabric 102 (see FIG. 8). Continuing to refer to FIG. 18, once the end-device identifier of the target resource has been determined, the multiprocessor interconnect transaction is encapsulated and transmitted across the network switch fabric (block 406), after which the transfer is complete (block 408).

The above discussion is meant to be illustrative of the principles and various embodiments of the present invention Numerous variations and modifications will become apparent to those skilled in the art once the above disclosure is fully appreciated. For example, although many of the embodiments of the present disclosure are described in the context of a PCI bus architecture, other similar bus architectures may also be used (e.g., HyperTransport™, RapidIO®). Further, a variety of combinations of technologies are possible and not limited to similar technologies. Thus, for example, nodes using PCI-X®-based internal busses may be coupled to each other with a network switch fabric that uses an underlying RapidIO® bus. Also, although the embodiments described in the present disclosure show the gateways incorporated into the individual nodes, it is also possible to implement such gateways as part of the network switch fabric, for example, as part of a backplane chassis into which the various nodes are installed as plug-in cards. Many other embodiments are within the scope of the present disclosure, and it is intended that the following claims be interpreted to embrace all such variations and modifications.

What is claimed is:

1. A computer system, comprising:
a first system node comprising a first processor;
a second system node comprising a second processor; and
a network switch fabric coupling together the first and second system nodes, the network switch fabric comprises a rooted hierarchical bus;
wherein identification information within a transaction is translated into a rooted hierarchical bus end-device identifier; and
wherein the transaction is transmitted from the first system node to the second system node, the transaction routed across the network switch fabric based upon the rooted hierarchical bus end-device identifier.

2. The computer system of claim 1, wherein the identification information comprises network identification information.

3. The computer system of claim 2,
wherein the first system node further comprises a gateway coupled to the network switch fabric; and
wherein the gateway translates the network identification information of the transaction, and further transmits the transaction.

4. The computer system of claim 2,
wherein the first system node further comprises a gateway coupled to both the first processor and the network switch fabric; and
wherein a network driver program executing on the first processor translates the network identification information of the transaction, and the gateway transmits the transaction.

5. The computer system of claim 2, wherein the transaction is configured for transmission according to a network messaging protocol that comprises at least one protocol selected from the group consisting of a transmission control protocol (TCP), an internet protocol (IP), a Fibre Channel protocol, a small computer system interface (SCSI) protocol, a serial attached SCSI (SAS) protocol, an Internet SCSI (iSCSI) protocol, and an Infiniband® protocol.

6. The computer system of claim 1, wherein the identification information comprises a multiprocessor interconnect end-device identifier.

7. The computer system of claim 6,
wherein the first system node further comprises a gateway coupled to the network switch fabric, and
wherein the gateway translates the multiprocessor interconnect end-device identifier within the transaction, and further transmits the transaction.

8. The computer system of claim 6,
wherein the first system node further comprises a gateway coupled to the network switch fabric and to the first processor; and
wherein a software program executing on the first processor translates the multiprocessor interconnect end-device identifier within the transaction, and the gateway transmits the transaction.

9. The computer system of claim 1, wherein the rooted hierarchical bus comprises at least one bus architecture selected from the group consisting of a peripheral component interconnect (PCI) bus architecture, a PCI Express® bus architecture, and a PCI-X® bus architecture.

10. The computer system of claim 11
wherein the first system node further comprises a first gateway coupled to the network switch fabric, the first gateway encapsulates the transaction according to a rooted hierarchical bus protocol of the network switch fabric; and
wherein the second system node further comprises a second gateway coupled to the network switch fabric, the second gateway unencapsulates the transaction according to the rooted hierarchical bus protocol of the network switch fabric.

11. The computer system of claim 1,
wherein the network switch fabric provides an active path between the first system node and the second system node that facilitates a first routing of the transaction, which travels along a first path constrained within a hierarchy of the rooted hierarchical bus; and
wherein the network switch fabric further provides an alternate path between the first system node and the second system node that facilitates a second routing of the transaction, which travels along a second path at least part of which is not constrained within the hierarchy of the rooted hierarchical bus.

12. The computer system of claim 1, wherein transmission of successive transactions from the first system node to the second system node is limited to an aggregate data transfer rate that is less than a maximum data rate of the network switch fabric.

13. The computer system of claim 1, wherein the transmission of the transaction is governed by quality of service rules defined by a protocol of the transaction.

14. The computer system of claim 1 wherein the transmission of the transaction is governed by quality of service rules defined by a protocol of the network switch fabric.

15. A network switch fabric gateway, comprising:
a processor configured to route a transaction between a network switch fabric and an interconnect of a system node within a computer system, and further configured to communicate with a software program
wherein the software program translates a device identifier into a rooted hierarchical bus end-device identifier according to a rooted hierarchical bus protocol of the network switch fabric; and
wherein the network switch fabric gateway is configured to transmit the transaction to the network switch fabric, the transaction formatted to be routed by the network switch fabric based upon the rooted hierarchical bus end-device identifier.

16. The network switch fabric gateway of claim 15, wherein the software program is configured to execute on a second processor external to the network switch fabric gateway.

17. The network switch fabric gateway of claim 16, wherein the device identifier comprises a multiprocessor interconnect end-device identifier.

18. The network switch fabric gateway of claim 15, wherein the network switch fabric gateway encapsulates the transaction according to the rooted hierarchical bus protocol of the network switch fabric.

19. The network switch fabric gateway of claim 15, wherein the software program comprises a virtual network driver, and wherein the device identifier comprises a network address.

20. The network switch fabric gateway of claim 19, wherein the transmitted transaction is formatted according to a network messaging protocol that comprises at least one protocol selected from the group consisting of a transmission control protocol (TCP), an internet protocol (IP), a Fibre Channel protocol, a small computer system interface (SCSI) protocol, a serial attached SCSI (SAS) protocol, an Internet SCSI (iSCSI) protocol, and an Infiniband® protocol.

21. The network switch fabric gateway of claim 15, wherein the software program comprises virtual interconnect software, and wherein the device identifier comprises a multiprocessor interconnect end-device identifier.

22. A method, comprising.
gathering data transfer information for a transaction, the data transfer information comprising an identifier of a target resource within a computer system;
converting the identifier into a corresponding rooted hierarchical bus end-device identifier; and
routing the transaction as it is transferred across a network switch fabric, the routing based upon the rooted hierarchical bus end-device identifier.
